(19) United States
(12) Patent Application Publication
(10) Pub. No.: US 2017/0025034 A1
(43) Pub. Date: Jan. 26, 2017

(54) Magic Music Method

(71) Applicant: Ernest Chapman, Nashville, TN (US)

(72) Inventor: Ernest Chapman, Nashville, TN (US)

(21) Appl. No.: 14/804,716

(22) Filed: Jul. 21, 2015

(51) Int. Cl. G09B 15/00; G09B 15/02

(52) U.S. Cl. CPC G09B 15/00; G09B 15/026

(57) ABSTRACT

A method of teaching music which utilizes a set of unique card and dice games, special charts and diagrams indicating finger and hand positions for keyboard, and a specific learning sequence, all of which teach the student how to play basic musical patterns such as notes, chords, scales, arpeggios, melodies, rhythms, and songs. This is taught in an organized sequence, before teaching the student how to read musical notation. Unlike standard methods which begin with the reading of musical notation, the Magic Music Method's sequence of skill acquisition begins with the student directly copying the teacher, and progresses to interactive card and dice games utilizing special charts and diagrams, which give the student the ability to play songs quickly. This allows for concrete visual and auditory instruction to occur before the student is expected to read musical notation. The foundation is keyboard, and the method may also be used to teach any other musical instrument, given the fact that piano proficiency is normally required for music majors no matter what their principal instrument may be, and given the fact that the method described herein has it's basis in the study of musical harmony, which may be applied to any instrument.

### BACKGROUND OF THE INVENTION

1. Field of the Invention

The present invention relates to the field of music education, and more particularly to a method of teaching piano, though it may be used for teaching any instrument with slight modifications. More specifically, the invention employs an innovative sequence of skill acquisition which allows students to learn how to play their instrument before they are confronted with the challenge of learning to read musical notation.

There are many methods of teaching music, but the two most common methods are the traditional methods having music notation as the focus of study (hereinafter “reading focused methods”) and the Suzuki method.

In reading focused methods, students are taught how to read musical notation as a means of acquiring all other musical skills. They learn how to look at a musical score and respond to the instructions in the score by placing their fingers on the correct notes and playing them in the correct sequence, with all attendant instructions such as rhythm, volume of notes played, and musical expression, encoded into the language of musical notation presented in the score. In order to play music, the student must first learn to read this coded language of musical symbols. This presents a barrier to learning for many students, and the acquisition of musical skills is often dependent on the student's ability to understand highly abstract information.

The Suzuki method is based on direct copying of the teacher, without the use of a musical score, and is used to teach a variety of musical instruments, including keyboard/piano. The student listens to and watches the teacher perform sections of musical songs and compositions, as well as warmup exercises, notes, scales, chords, and arpeggios, and then copies the teacher directly. Everything is learned by mimicking the teacher, in the same way that a child learns to speak their native language by mimicking their parents. Eventually, Suzuki students may learn to read musical notation, but only after they have spent years learning to play songs by ear. This can cause problems for many students who do not progress to the point of learning to read music, and then transfer to other teachers using reading focused methods. Music games, charts with shapes and patterns, and free improvisation are not a part of the Suzuki method, though Suzuki teachers may choose to employ them as supplements.

2. Description of the Prior Art

Other prior art systems are focused specifically on using games involving customized game boards, game pieces, and customized card decks and dice, as a means of learning to read musical notation. The Magic Music Method card games do not utilize special decks of cards, or “flash cards”, which are a common tool to teach musical notation. Rather than using special card decks, this method uses normal playing cards in combination with special charts and diagrams that represent visual maps of the instrument, such as piano. Rather than focusing on musical notation, the Magic Music Method uses specific charts and diagrams which teach the student how to move their hands and fingers into the correct shapes and patterns to build a musical vocabulary. This can be applied to non-keyboard instruments with similarly constructed visual maps that correspond note locations with the charts and diagrams in FIGS. 4, 8, and 11.

There are existing card decks and card games consisting of special playing cards used to teach the reading of musical notes (U.S. Pat. No. 6,111,180 (DiGiulio), U.S. Pat. No. 6,588,756 (Hughes)). Each card has specific musical instructions printed on it, and each of these examples differs significantly from the use of cards and card games in the Magic Music Method due to the fact that these patents involve special cards, printed with specific instructions on each card. The Magic Music Method is unique in this respect because the card games can be played with any standard deck of playing cards and only requires the use of special charts and diagrams which give the cards different meanings depending on the game being played and the instrument in question.

There are also existing musical dice and musical dice games utilizing special dice manufactured with images of musical notes, rhythms, chords, and instructions on them (U.S. Pat. No. 20050109193 A1 (Wolfe), U.S. Pat. No. 20110031692 A1 (Siegel)). These differ significantly from the Magic Music Method dice games due to the fact that they require the purchase of specially manufactured dice, which have musical ideas and instructions printed on the faces of the dice. In contrast, the Magic Music Method uses any standard 6-sided dice, the numbers of which are made to correspond to specific instructions given on the charts and diagrams. Thus, the Magic Music Method dice games are distinctly different from other dice games due to the fact that they do not require special dice, and they do require the use of special charts and diagrams which give the dice different meanings depending on the game being played.

Even in the case of prior art potentially found to be using standard cards and dice, the distinction remains in the diagrams used in connection with said cards and dice. Thus, the Magic Music Method stands out as unique due to the special nature of it's charts and diagrams, described below in the “Brief Description of the Drawings”.

Other patented methods of teaching music differ significantly from the Magic Music Method due to the fact that they are focused on the acquisition of reading skills as a means of instruction (U.S. Pat. No. 6,015,947 (Moberg), U.S. Pat. No. 6,388,182 (Bermúdez)). Other game based systems of music instruction have highly specific instructions which differ significantly from the Magic Music Method's four step sequence (described in “Summary of the Invention”), and typically involve special game boards, special game pieces, and/or custom manufactured cards and/or dice (U.S. Pat. No. 7,325,805 (Ritchie, Ragner), U.S. Pat. No. 4,465,282 (Dillon), and U.S. Pat. No. 4,895,374 (Bowles)).

U.S. Pat. No. 5,540,132 (Hale) uses symbols to teach musical notation. U.S. Pat. No. 702,298 (Frederickson) uses a special deck of musical cards to teach the reading of musical notation. U.S. Pat. No. 4,465,282 (Dillon) and U.S. Pat. No. 4,895,374 (Bowles) use board games for musical education. U.S. Pat. No. 8,835,737 B2 (King) describes a system of piano tablature that vertically orients the score and uses special symbols to indicate note value and rhythmic duration, which is very different from the Magic Music Method's vertical charting system for chords shown in FIG. 10, as the Magic Music Method system does not use a grid for the notes, does not include a picture of the piano, uses a different set of symbols based on Magic Music Blocks (FIG. 2) to show note values, and does not indicate any complexities of rhythm. The vertical display in FIG. 10 only shows the layout of the chords, and does so in a way that has a different intended purpose than piano tablature. The purpose is to spell chords, in contrast to the purpose of piano tablature, which is to represent as much information as possible, leading to an identical performance to what would be achievable with standard sheet music.

U.S. Pat. No. 6,898,153 (Della Rossa) comprises a mechanical clock that has musical symbols placed around it, and plays music on the hour as the clock hands point to different musical concepts. Unlike this mechanical clock, the “Clock Of Fifths” diagram utilized in the Magic Music Method is an educational chart integrating representations of the circle of fifths in the form of “Magic Music Blocks”, placed around a clock-like image. In this image, the hours signifying time on the clock have been replaced by playing cards in a specific and unique visual array. The time “12 O'Clock” is replaced by the “Queen” playing card, the time “1 O'Clock” is replaced by the “Ace” playing card, and the times “2 O'Clock” through “10 O'Clock” are replaced by playing cards having the numbers 2-10 respectively. The time “11 O'Clock” is replaced with the “Jack” playing card. This enables the diagram to be used as an educational tool with a pack of common playing cards, allowing a randomly selected card to indicate the note which appears next to in instance of that card in any suit on the diagram. Thus, a randomly selected “3” card of any suit is paired up with the time “3 O'Clock”, and signifies the note indicated next to “3 O'Clock”, which is the note “A”. This diagram is used to randomly select notes for the student to find on the piano, and they can proceed to play the note selected, or play chords, scales, and finger positions built upon that note, or play any number of other requested musical patterns based on the note selected. Non-keyboard instruments may use the diagram to instantly see which notes on the circle of fifths are sharp and flat, and can visualize scale patterns based on the map of their instrument using the card and dice games described below by simply adapting the concept of black and white piano keys to natural, sharp, and flat notes on their respective instruments.

### SUMMARY OF THE INVENTION

The Magic Music Method teaches music with a highly specific, four-step process integrating new card and dice games with a set of unique charts and diagrams that teach the student all of the fundamental patterns of music using “Magic Music Blocks”. In the example of keyboard study, these Magic Music Bocks are combined in different ways to create a visual library of all of the basic patterns of music including but no limited to: 24 basic chords, 72 chord inversions, 24 basic Five-Finger hand positions, all the basic major and minor scales, and vertically oriented charts demonstrating chord patterns. This has the effect of allowing students to learn piano through directly copying their teacher, in combination with a pre-reading curriculum composed of Magic Music Blocks, making it much easier to learn to read music as soon as the student is ready.

This is accomplished in four stages:

1. Direct demonstration of each concept (24 basic chords, 72 chord inversions, 24 basic Five-Finger hand positions, all the basic major and minor scales, and vertically oriented charts demonstrating chord patterns) by the teacher either in person or through video recordings, allowing the student to see how each musical pattern is formed by the hands, hear the sounds it makes, and directly copy the teacher.

2. Musical card and dice games teaching the core skills (24 basic chords, 72 chord inversions, 24 basic Five-Finger hand positions, all the basic major and minor scales, and vertically oriented charts demonstrating chord patterns) using special charts including but not limited to the “Clock of Fifths” chart, the “24 Basic Chords” chart, the “Scale Degrees and Dice” chart, the “Piano Map” chart, the “Five Finger Patterns” chart, the “Scale Patterns” charts, and any other chart using “Magic Music Blocks” arranged in such a way as to visually demonstrate exact note names in an array which may be copied by placing fingers on the indicated notes on the piano and pressing the notes down.

3. The learning of songs which utilize the core patterns previously learned (24 basic chords, 72 chord inversions, 24 basic Five-Finger hand positions, all the basic major and minor scales, and vertically oriented charts demonstrating chord patterns).

4. The transition to reading standard musical notation, which is now much easier due to the fact that 24 basic chords, 72 chord inversions, 24 basic Five-Finger hand positions, all the basic major and minor scales, and vertically oriented charts demonstrating chord patterns, have been previously learned and memorized, and represent the basic vocabulary of the musical language.

Furthermore, all of these patterns may be adapted to the way notes are physically mapped across any other instrument, and similarly structured charts may be generated using Magic Music Blocks.

These patterns can be thought of as the core musical vocabulary, which is required for the student to be capable of playing songs and compositions. Learning this core musical vocabulary before learning to read musical notation is like learning how to speak a language, such as English, before being expected to read and write the language. This is often called “playing by ear” in music education. Unlike other methods which utilize playing-by-ear instruction, the Magic Music Method categorizes all of the fundamental skills and core patterns required to play music into a set of visually engaging and easy to read charts and diagrams, and utilizes new, innovative card and dice games, using a standard deck of playing cards and normal dice, to drill and memorize these concepts in an organized sequence.

The present invention is of such a scope as to include card and dice games that teach notes, chords, scales, chord inversions, chord progressions, improvisation, composition, and all levels of music theory. Teachers using the method may introduce musical notation as soon as the student is ready for it, and the Magic Music Method may be used as a supplement to other teaching methods, especially in the case of students who struggle with reading musical notation, need extra help, or have a learning disability.

It is an advantage that the card and dice games may be played with any standard deck of cards and any standard dice, and that the charts and diagrams use intuitive, visual presentations of musical ideas which may be memorized through playing the games.

It is a further advantage that the acquisition of the keyboard skills of playing 24 basic chords, 72 chord inversions, 24 basic Five-Finger hand positions, all the basic major and minor scales, and vertically oriented charts demonstrating chord patterns, directly leads to the ability of a student to quickly learn to play their favorite songs before being expected to read music.

It is a further advantage that the pre-reading notation system created by “Magic Music Blocks” makes the acquisition of the skill of reading musical notation easier, thus separating the present invention from other ear based methods such as Suzuki which do not focus as much on pre-reading shapes and patterns.

It is a further advantage that diagrams utilizing “Magic Music Blocks” may be placed into standard musical scores, creating a visual connection between the patterns as learned in the Magic Music Method and the patterns as indicated in standard musical notation.

It is another advantage that any music teacher of ordinary skill in the art can easily learn the method, interpret and understand the diagrams, play the card and dice games, and demonstrate and teach the skills and techniques of the Magic Music Method to their students.

Yet another advantage is that the learning sequence is clearly divided into four stages, which allow students and teachers to know exactly where they are in the sequence.

A still further advantage is that the present invention allows for a certain degree of creativity and innovation on the part of the teacher and the student, who can integrate it with other methods of choice and create their own games for skill acquisition using creativity and improvisation.

### BRIEF DESCRIPTION OF THE DRAWINGS

FIG. 1 shows the four stages of the Magic Music Method spiral learning sequence.

FIG. 2 shows the Magic Music Blocks which are used to signify specific notes. These blocks can be re-arranged in a variety of different ways to indicate any pattern of notes, chords, scales, melody, or harmony.

FIG. 3 shows the Piano Map diagram used by students to associate the Magic Music Blocks note name with a specific piano key.

FIG. 4 shows the Clock of Fifths diagram, which uses Magic Music Blocks and a standard deck of playing cards to select notes for the student to play. Once a note is selected, the student may simply play the note, or they may look at the other charts and play chords, finger patterns, or scales that are based on the selected note.

FIG. 5 shows the 24 Basic Chords diagram, which is a visual representation of the shapes and patterns necessary to play the 24 basic major and minor chords on piano.

FIG. 6 shows the Five Finger Patterns diagram, which uses Magic Music Blocks to show basic hand positions for piano.

FIG. 7 shows the Scale Patterns chart, which uses Magic Music Blocks to visually identify families of scales by their shape and fingering.

FIG. 8 shows the Scale Degrees and Dice chart, which uses Magic Music Blocks and images of dice to associate numbers on the dice with notes in any given scale. It functions like a multiplication table or a database of information, queried by the selection of a starting note which identifies the scale to be used, and a dice roll which identifies the notes or chords to be played.

FIG. 9 shows the Chord Inversions Chart, which is used to visually identify the shapes and patterns of chord inversions once a chord has been selected by the student.

FIG. 10 shows a vertically oriented chord chart enabling a student who does not yet know how to read music to play Prelude in C by Bach. They read each row of notes across from left to right and place their fingers on the notes with the hand indicated, then press them down to make the chord.

FIG. 11 shows the application of Magic Music Blocks to musical notation, revealing the hand positions necessary to play sections of the song Arabesque by Burgmuller. Once the student knows the basic shapes and patterns, they are ready to begin reading musical notation. Presenting both Magic Music Blocks and standard notation side by side creates a mental connection between the two concepts.

### DETAILED DESCRIPTION

In the following description, for purposes of explanation and not limitation, specific details are set forth in order to provide a thorough understanding of the present invention. However, it will be apparent to those skilled in the art that the present invention may be practiced in other embodiments that depart from these specific details. For example, this method may be applied to keyboard instruments as well as any other instrument, including but not limited to stringed instruments, wind instruments, horns, pitched percussion instruments, voice, synthesizer, or any combination thereof. In other words, the preferred embodiments described below are not described in a way to unnecessarily limit the breadth and scope of the claimed invention.

The description now turns to the figures. The one or more embodiments of the invention may be understood by reference to the figures. The following description is intended only by way of example and simply illustrates one or more embodiments of the invention as claimed herein.

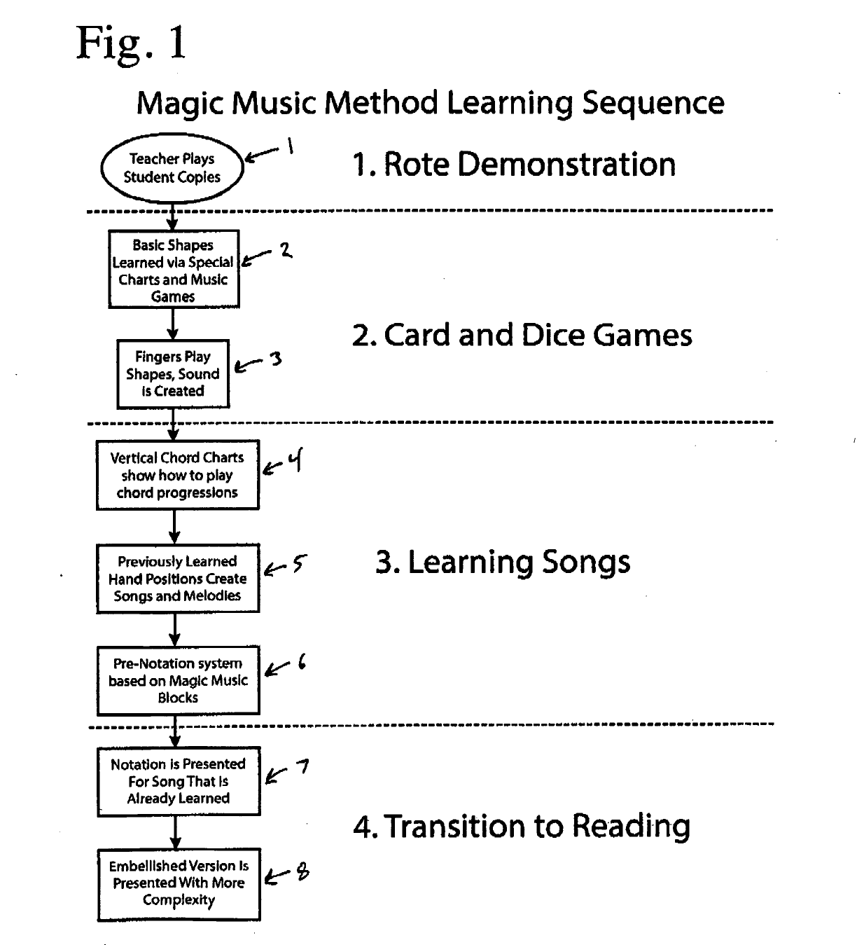

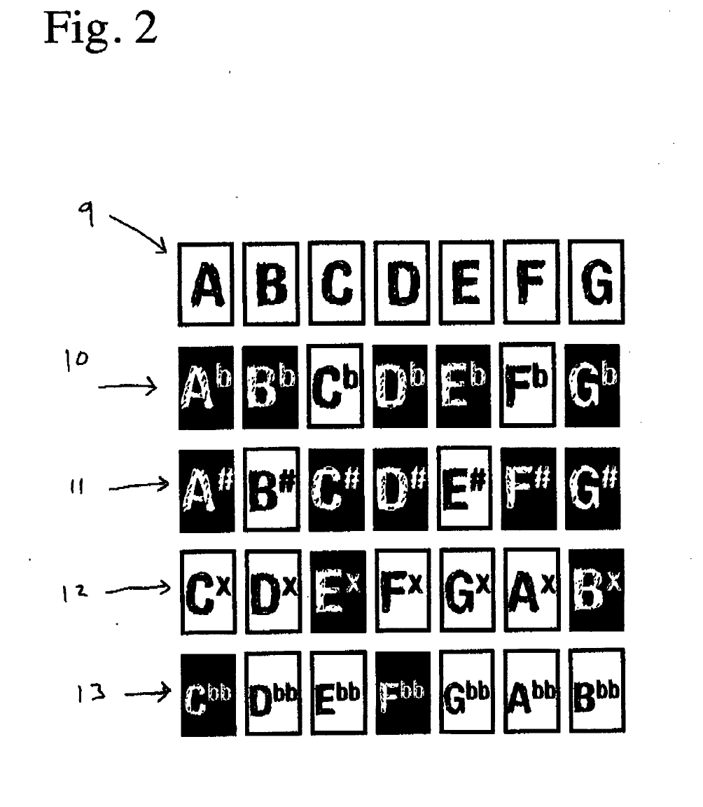

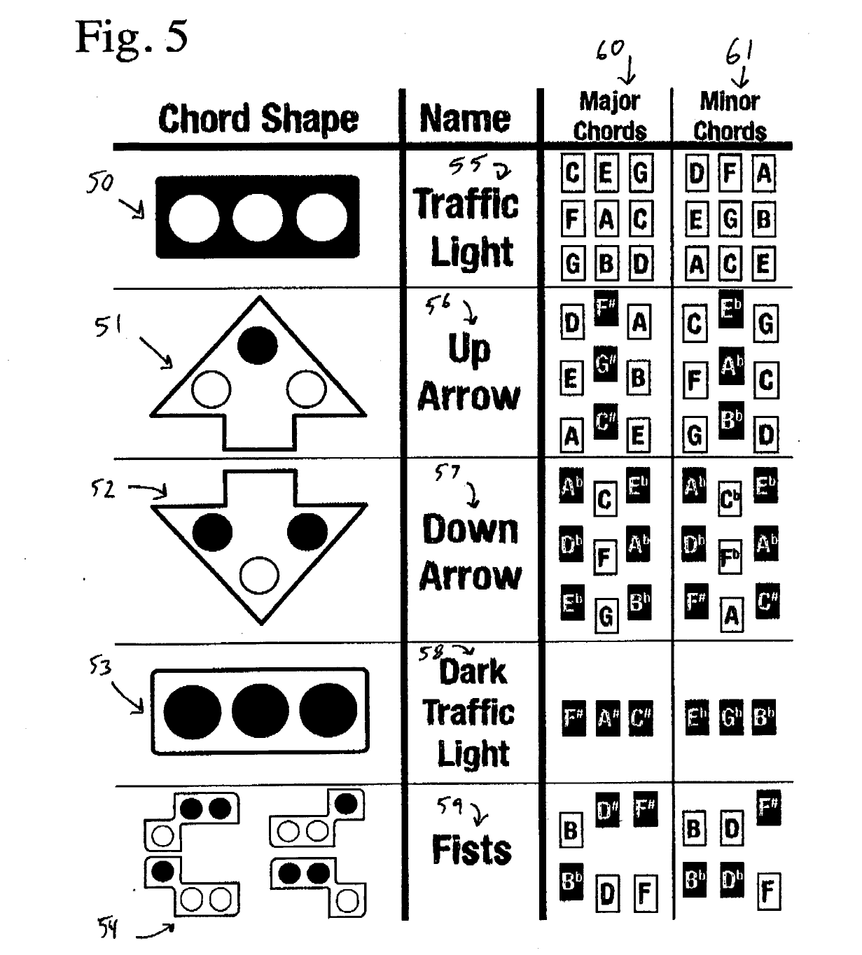

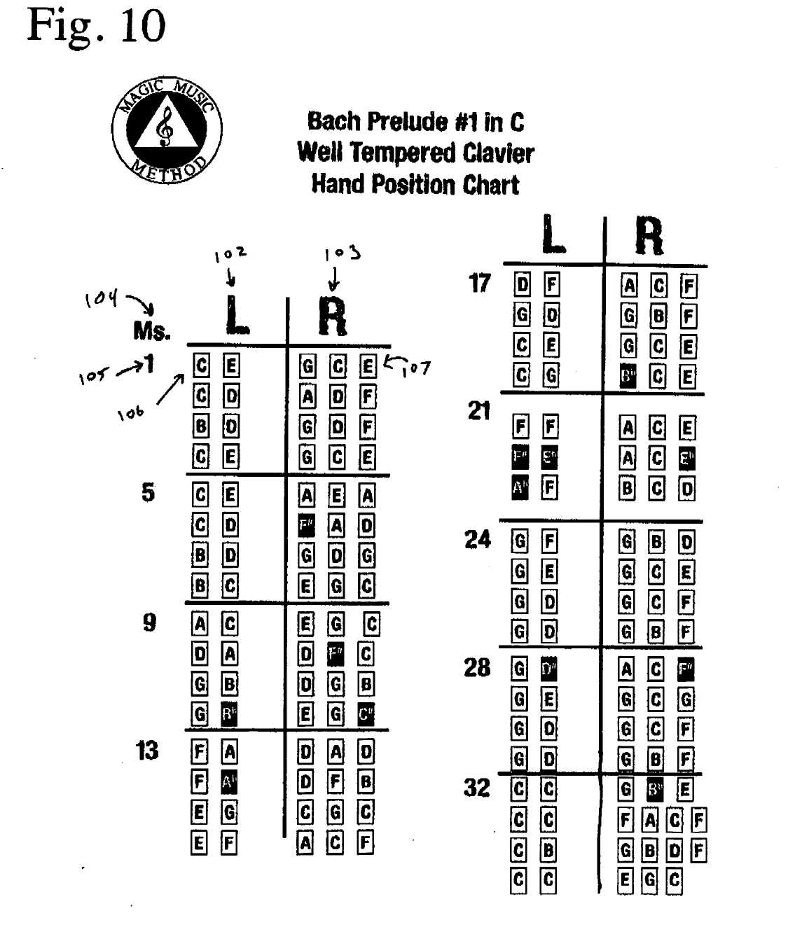

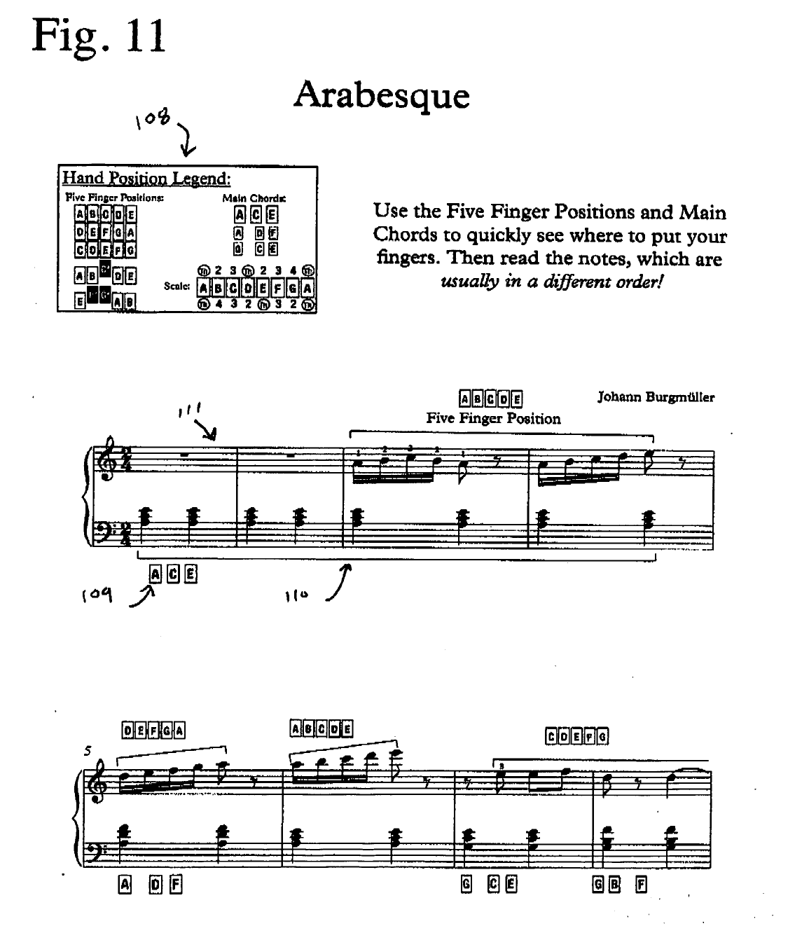

The Magic Music Method Learning Sequence (FIG. 1) is composed of four clear stages, which may be repeated for each new concept introduced to the student. In the first stage 1, the student is directed to watch the teacher play, listen to them, and directly copy them. Very quickly, the student will begin learning basic shapes and patterns using the diagrams in FIGS. 5-9, and will move into the second stage of the sequence show in FIG. 1, the “Card and Dice Games” stage 2, 3. By playing shapes and patterns, sound is instantly created and the student hears familiar sounds of notes, chords, and scales. Next, they move into the third stage, and begin learning songs 4, 5, 6, by studying special chord charts as indicated in (FIG. 10) constructed with the use of Magic Music Blocks (FIG. 2). When the student is ready, they progress to the fourth stage of the sequence and transition to reading standard musical notation 7, 8, which is annotated with Magic Music Blocks patterns as seen in FIG. 11 109, 110. Like training wheels, these annotations disappear once the student no longer needs them. The four stages may be repeated as necessary for each new concept introduced, until the student has developed a vast library of musical skills and memorized patterns, at which point they may learn new concepts at a faster pace.

Magic Music Blocks (FIG. 2) are used throughout the method in a variety of ways including, but not limited to, the visual construction of note patterns, chords, hand positions, chord inversions, scales, and chord charts. Magic Music Blocks can indicate natural white keys 9 on the piano, as well as flatted notes 10, sharped notes 11, double-sharped notes 12, and double flatted notes 13.

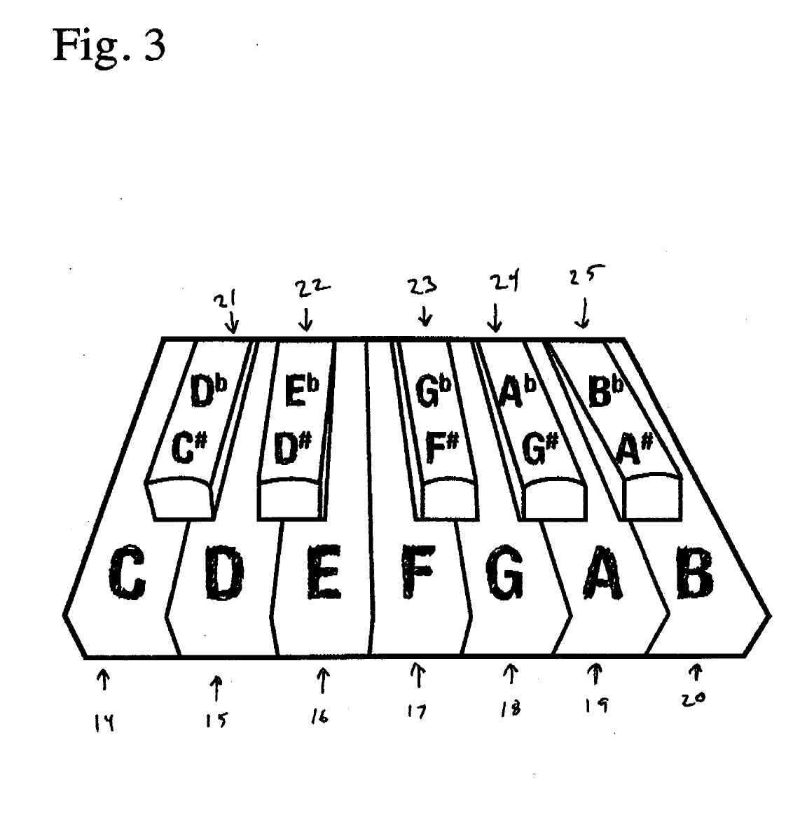

The most commonly encountered note names are shown in FIG. 3 on a visual map of the piano, which clearly differentiates the white keys 14-20 from the black keys 21-25. The black keys 21-25 all have two different possible names.

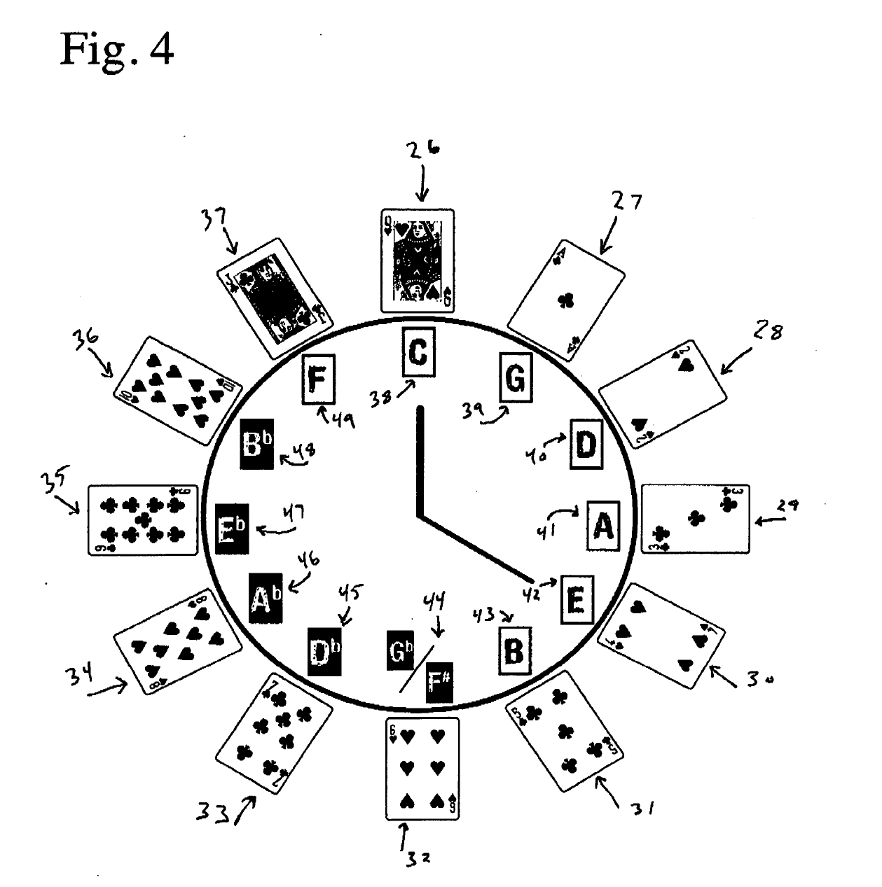

When placed next to the Clock of Fifths diagram (FIG. 4), the notes reappear in specific locations 38-49 around the clock. In FIG. 4, the notes Db 45, Ab 46, Eb 47, and Bb 48 are all spelled as “flat” notes only, rather than with both names as seen in FIG. 3 21, 22, 24, 25. Furthermore, in FIG. 4, the note at 44 is spelled with both possible names. This is an innovation that makes the entire system of music theory easier for a beginner student to start learning with minimal confusion.

In FIG. 4, each note is associated with a playing card from a standard deck of cards 26-37. For example, the note “C” 38 is associated with the “Queen” card 26. The association is the same for each number or face value of the selected card, irrespective of the suit of the card. The list of associations as is as follows:

“C” 38 is associated with any “Queen” card 26.
“G” 39 is associated with any “Ace” card 27.
“D” 40 is associated with any “2” card 28.
“A” 41 is associated with any “3” card 29.
“E” 42 is associated with any “4” card 30.
“B” 43 is associated with any “5” card 31.
“F#/Gb” 44 is associated with any “6” card 32.
“Db” 45 is associated with any “7” card 33.
“Ab” 46 is associated with any “8” card 34.
“Eb” 47 is associated with any “9” card 35.
“Bb” 48 is associated with any “10” card 36.
“F” 49 is associated with any “Jack” card 37.

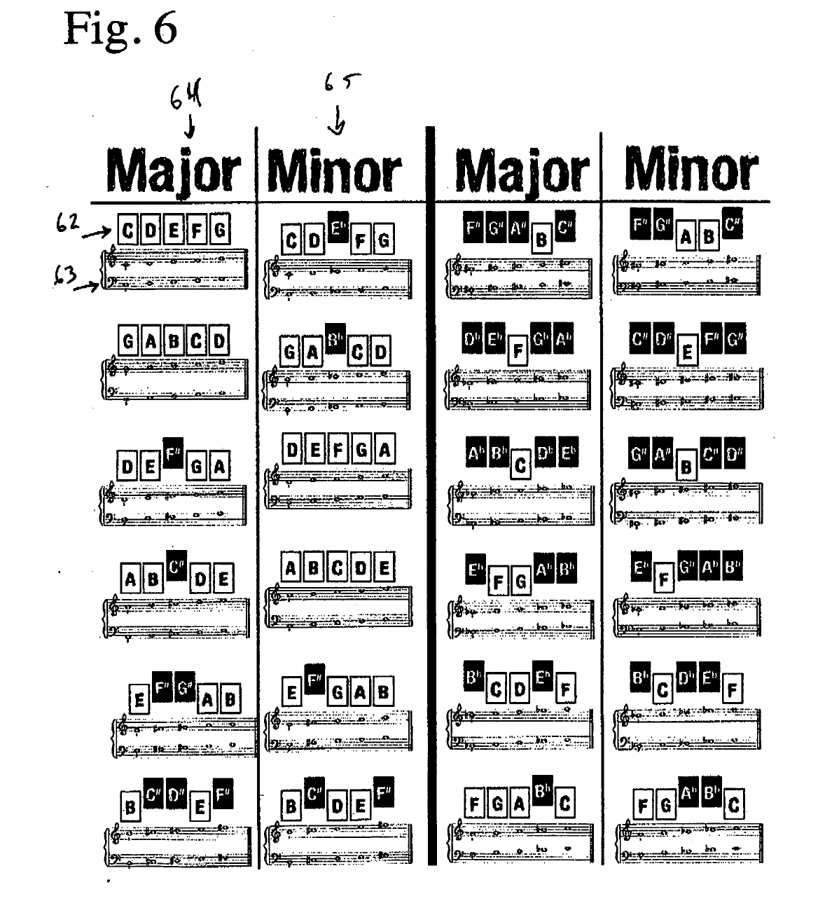

Once the note names have been learned, the student is directed to FIG. 5, which displays a series of specific visual shapes 50-54 that each have specific names 55-59 relating to the appearance of the shapes. These named shapes constitute categories which reflect the visual appearance of the white and black key combinations of the chords within each category, listed in columns 60 and 61. The student is then directed to select a random playing card, look up the card's location on FIG. 4, and then select and play the chord in either the Major Chords column 60 or the Minor Chords column 61 which has as it's first note the note which corresponds to the card selected in FIG. 4. FIG. 6 contains a similar chart to FIG. 5, only instead of categories based on the shape of a chord, there are rows of notes 62 hovering above standard musical notation of said notes 63. There are 24 of such groupings, organized into columns of Major 64 and Minor 65 Five-Finger hand positions. These are common playing positions which help beginner piano students to learn to play basic melodies.

Similar to FIG. 5, a student working with FIG. 6 will be asked to select a random card, look at FIG. 4 to find the note it corresponds to, and then they will be asked to put their fingers into the corresponding Five-Finger position which has as it's first note the note which corresponds to the card selected in FIG. 4. They may then be asked to play a specific finger exercise, or to play a melody which is shown to them by the teacher, or by looking at a series of Magic Music Blocks composed of the same notes in the Five-Finger position they are using.

Musical scales are taught in the same way, with Magic Music Blocks as the building blocks of charts that show visual representations of the notes of the scales grouped by fingering category. FIG. 6 shows the five categories. Each category has a special name 66 which lists the key-notes of the scales in said category under the name of the category. The fingering pattern 67 is the same for each scale in a given category. Each instance of a scale that uses a given fingering is displayed with right hand fingerings 68 on top, the notes of the scale spelled out with Magic Music Blocks 69, and the left hand fingering on the bottom 70. The key-note of the scale in each instance 71 is displayed to the left of the Magic Music Blocks diagram of said scale.

Thus it can be seen that the card game described above, which utilizes FIG. 4, can be used to select a single note, the first note of a chord, the first note of a Five-Finger position, or the key-note of a scale, which the student is then directed to play according to the teacher's specifications. More extensive information, such as exact fingerings in specific situations, is left to the teacher's discretion. By selecting multiple cards, the student may, if they wish, construct a randomly generated chord progression. There are many variations for the card game which motivate and inspire the creativity of students wishing to learn the fundamentals of music.

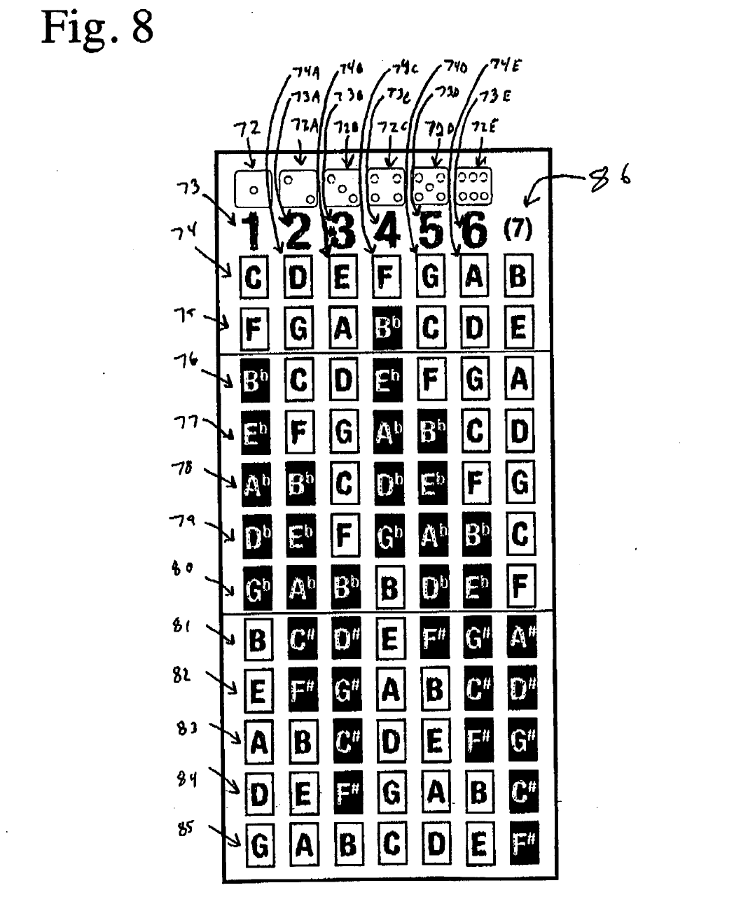

FIG. 8 shows a table of scales having at the very top a pictorial representation of the numbers 1-6 as displayed on the faces of a standard 6-sided die 72. Under the images of dice there is a row of arabic numerals which make clear the numbers corresponding to each die 73. Each row of notes 74-85 represents the notes of a major scale, or “key”, as defined in the study of standard music theory. Due to the fact that scales have 7 notes, the 7th note of each scale does not have a die associated with it 86. This makes it possible for the dice games to have a dual purpose. Dice can indicate notes, or they can indicate chords starting with the notes selected. When a student is beginning to learn music theory, the first six chords of a given key are easier to learn than the 7th chord, and so this allows them to build confidence with simple chords before moving on to more complicated matters.

By rolling a handful of dice, students can generate a random melody in a key that has been selected by a random playing card. Alternately, the teacher may select the starting key and roll the dice for the student, or the student may select the melody and then pick a card to randomly select a new key to play the melody in. There are many, many applications for this game in the field of applied music theory, wherein concepts such as notes, chords, and scales, and even modes, are applied to a given instrument for purposes of performance, composition, improvisation, or general study. This can be applied to every instrument, and so the application of this method, while currently focused on piano, is not limited to the piano.

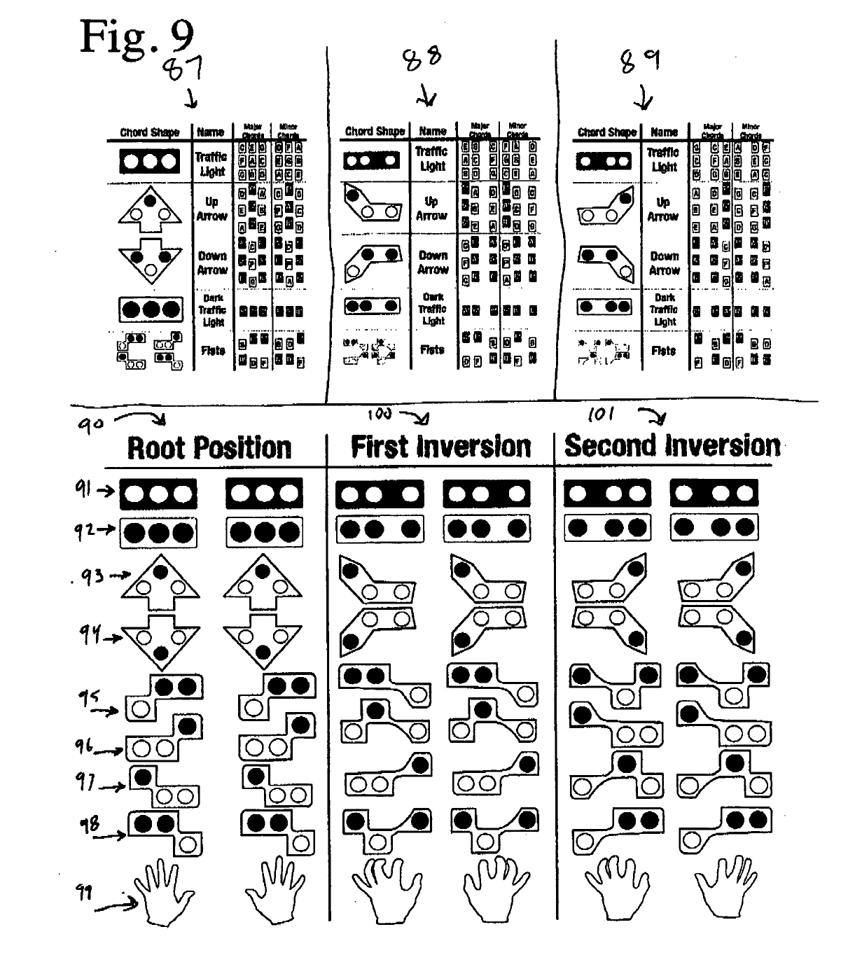

FIG. 9 shows a group of charts used to teach students how the basic chord shapes from FIG. 5 can be transformed through a process called “Inversion”, wherein the same notes are rearranged in different order from left to right in all possible combinations, in linear sequence. The “root position” chords 87 with corresponding shapes 90 are seen to “invert” to “first inversion” chords 88 with corresponding shape changes 100, again to “invert” to “second inversion” chords 89 with corresponding shape changes 101. Each shape 91-98 is shown for the right and left hands 99 and when read from left to right, the shapes can be seen to transform.

When the student is ready to start learning songs, they encounter diagrams such as FIG. 10, which orients the page vertically and allows them to see, one row at a time, the notes of each chord 106, 107 displayed underneath indications for the left hand 102 and the right hand 103. Where appropriate, measure numbers 104, 105 are indicated. This chart is one example of many possible songs that can be displayed in this manner, which is significantly different from standard notation. Because it does not place the notes on any kind of strict grid, and does not attempt to account for very many intricacies of rhythm or phrasing, it is in a separate category from piano tabs. It simply shows what's called a “chord voicing” in a new and unique way, which can be quickly played. The details of performance must be learned by ear and in the first stage of the learning sequence 1 which is returned to often.

Because of the nature of the information being studied, the card and dice games are returned to constantly and the teacher is constantly putting the student through each stage of the learning sequence for each new concept the student encounters. Thus, it is a spiral curriculum, as defined by educational theorist Jerome Bruner. Using the same tools, concepts and skills are repeated and then returned to at higher and higher levels of proficiency.

FIG. 11 shows what happens in stage 4 of the learning sequence, when the student begins to encounter musical notation. As they learn how to read music 111, the Magic Music Blocks appear as annotations to guide their fingers to the right notes 109, 110. Like a cookbook, the ingredients necessary to play the song are listed at the beginning; in this case, in a “hand position legend” 108 which displays all of the necessary musical patterns with Magic Music Blocks.

The invention claimed is:

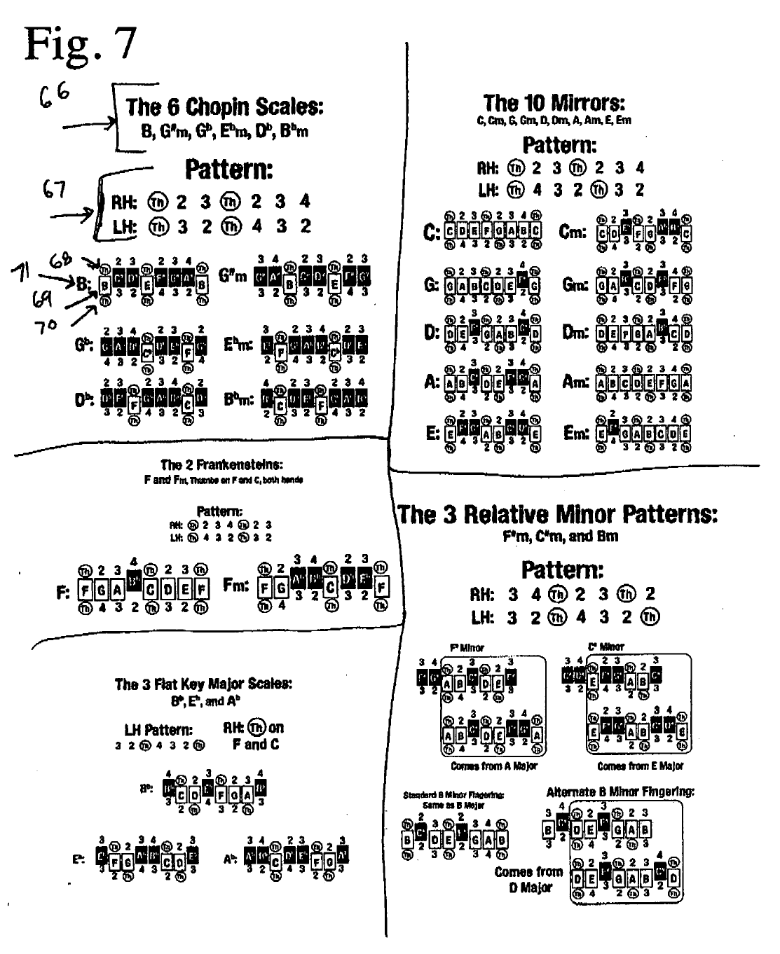

1. A method of teaching music in a four-stage spiral learning sequence, wherein the teacher is:
Demonstrating, either in person or via recorded video or videoconference, the skills of playing notes, chords/arpeggios, scales, chord inversions, various hand positions, melodies and songs to the student(s) who copies by the teacher directly (Stage 1);
Playing and teaching the student to play musical card and dice games in which the selected card(s), from a standard deck of playing cards, corresponds to the musical note(s) as shown in FIG. 4, and/or the selected dice number(s), from normal 6-sided dice, corresponds to the musical note(s) as shown in FIG. 8 (Stage 2);
Querying of a set of specific charts utilizing different configurations of Magic Music Blocks (FIG. 2) in order to discover and learn to play musical patterns related to the notes chosen by said randomly selected card and dice, said charts including, in any particular order, “Piano Map” (FIG. 3), “Clock of Fifths” (FIG. 4), “24 Basic Chords” (FIG. 5), “Five Finger Patterns” (FIG. 6), “Scale Patterns” (FIG. 7), “Scale Degrees and Dice” (FIG. 8), and “Chord Inversions” (FIG. 9), and any combination of said charts thereof, or reconfigured charts consisting of Magic Music Blocks arranged in such a way as to direct the student to play specific note patterns (Continuation of Stage 2);
Teaching the student(s) to play songs and compositions as presented with Magic Music Blocks in a vertically oriented manner as shown in FIG. 10 (Stage 3);
Transitioning the concrete skills learned in the above stages, to the study of musical notation with the student(s) viewing charts that place Magic Music Blocks next to standard musical notation as in FIG. 11 (Stage 4);
and
Repeating the four stages described above, as necessary, with each new concept introduced to the student(s).

2. A method of teaching music in a four-stage spiral learning sequence as recited in claim 1, further comprising the teaching of music on any musical instrument, including but not limited to keyboard instruments, stringed instruments, wind instruments, horns, pitched percussion instruments, voice, synthesizer, or any combination thereof.

3. A means of displaying specific musical notes using black and white rectangles called Magic Music Blocks for use in the special charts and diagrams of the Magic Music Method, which involves:
Displaying black piano keys as black rectangles containing the names of specific notes inside of them, according to the conventions of standard music theory, in white text, as in FIG. 2;
Displaying white piano keys as white rectangles with black border, containing the names of specific notes inside of them, according to the conventions of standard music theory, in black text, as in FIG. 2.

4. A means of displaying specific musical notes using black and white rectangles called Magic Music Blocks as recited in claim 3, wherein said Magic Music Blocks are arranged into the basic patterns of notes and chords, as in FIG. 5.

5. A means of displaying specific musical notes using black and white rectangles called Magic Music Blocks as recited in claim 3, wherein said Magic Music Blocks are arranged into the basic patterns of Five-Finger positions, as in FIG. 6.

6. A means of displaying specific musical notes using black and white rectangles called Magic Music Blocks as recited in claim 3, wherein said Magic Music Blocks are arranged into the basic patterns of musical scales as in FIG. 7 and FIG. 8, including but not limited to Major and Minor scales and modes, such as Lydian, Ionian, Mixolydian, Dorian, Aeolian, Phrygian, and Locrian.

7. A means of displaying specific musical notes using black and white rectangles called Magic Music Blocks as recited in claim 3, wherein said Magic Music Blocks are arranged into the basic patterns of extended arpeggios of 7th chords, various advanced chords such as jazz chords and chords with extensions of 9ths, 11ths, and 13ths, as defined by standard music theory.

8. A means of displaying specific musical notes using black and white rectangles called Magic Music Blocks as recited in claim 3, wherein said Magic Music Blocks are arranged into the basic patterns of chord progressions, as in FIG. 10, for the purpose of teaching harmony.

9. A means of displaying specific musical notes using black and white rectangles called Magic Music Blocks as recited in claim 3, wherein said Magic Music Blocks are arranged into the basic patterns of chord progressions, as in FIG. 10, for the purpose of teaching songs and compositions.

10. A means of displaying specific musical notes using black and white rectangles called Magic Music Blocks as recited in claim 3, wherein said Magic Music Blocks are arranged into the basic patterns of intervals and note clusters for the purpose of teaching music with pre-notation style instruction.

11. A means of displaying specific musical notes using black and white rectangles called Magic Music Blocks as recited in claim 3, wherein said Magic Music Blocks are arranged into any of the above mentioned patterns and then superimposing such patterns onto standard musical notation, as a form of annotation which visually reveals the notes encoded into the notation, which may not have previously been obvious to the student(s) attempting to read said notation, as in FIG. 11.

12. A means of displaying specific musical notes using black and white rectangles called Magic Music Blocks as recited in claim 3, wherein said Magic Music Blocks are arranged into graphics libraries which can then be used in the development of instructional material, method books, and teacher training materials.

13. A musical game which involves:
Selecting a random card from a standard deck of playing cards and associating the selected card, irrespective of suit, with musical notes as shown on FIG. 4, wherein “C” 38 is associated with any “Queen” card 28, “G” 39 is associated with any “Ace” card 27, “D” 40 is associated with any “2” card 28, “A” 41 is associated with any “3” card 29, “E” 42 is associated with any “4” card 30, “B” 43 is associated with any “5” card 31, “F#/Gb” 44 is associated with any “6” card 32, “Db” 45 is associated with any “7” card 33, “Ab” 46 is associated with any “8” card 34, “Eb” 47 is associated with any “9” card 35, “Bb” 48 is associated with any “10” card 36, and “F” 49 is associated with any “Jack” card 37;
Identifying and playing the note thus selected on a keyboard instrument;
Identifying and playing various musical patterns which use the note or notes selected, in the form of chords, scales, finger patterns, chord progressions, and songs, with the help of Magic Music Blocks organized into charts following the format and design of FIGS. 4, 5, 6, 7, 8, 9, and 10;
Selecting a musical scale from FIG. 8, the starting note 74-85 being chosen by the randomly selected card as described above;
Rolling standard six sided dice and associating the dice numbers rolled with musical notes as displayed on FIG. 8, the starting note 74-85 having being previously selected by the above selected card, and wherein a die face displaying “1” 72 is associated with the first degree 73 of any given scale 74, a die face displaying “2” 72a is associated with the second degree 73a of any given scale 74a, a die face displaying “3” 72b is associated with the third degree 73b of any given scale 74b, a die face displaying “4” 72c is associated with the 4th degree 73c of any given scale 74c, a die face displaying “5” 72d is associated with the fifth degree 73d of any given scale 74d, and a die face displaying “8” 72e is associated with the sixth degree 73e of any given scale 74e;
Proceeding to play the notes thus selected by the dice roll on a keyboard instrument;
Proceeding to play chords based on the notes thus selected by the dice roll on a musical instrument, using the conventions of standard music theory to either play chords/arpeggios as they appear in the selected key or to modify said chords according to the conventions of standard music theory;
and
Giving the teacher a flexible system of randomly generating technical assignments on the spot, based on the skill level of the student(s), so that the teacher's creativity is also engaged.

14. A musical game as recited in claim 13, wherein selected notes form the basis of improvised or composed melodies for the student(s) to play.

15. A musical game as recited in claim 13, wherein selected notes form the basis of chords and chord progressions for the student(s) to play.

16. A musical game as recited in claim 13, wherein selected notes select finger positions for the student(s) to play exercises and/or melodies within.

17. A musical game as recited in claim 13, wherein selected notes become key-notes for the purpose of teaching a student how to transpose musical patterns, melodies, and songs from one key to another.

18. A musical game as recited in claim 13, wherein selected notes are used to engage the creativity of the student(s) by placing them in a randomly generated musical situation which inspires them to move their fingers across new shapes and patterns, generating new musical sounds, leading to improvisation and composition.

19. A musical game as recited in claim 13, wherein selected notes form the basis of improvised or composed melodies for the student(s) to play;

20. A musical game as recited in claim 13, further comprising the execution of musical patterns on any other musical instrument, including but not limited to stringed instruments, wind instruments, horns, pitched percussion instruments, voice, synthesizer, or any combination thereof.
